(19) United States
(12) Patent Application Publication
(10) Pub. No.: US 2024/0183175 A1
(43) Pub. Date: Jun. 6, 2024

(54) WALL SILL ASSEMBLY AND WALL CONSTRUCTION HAVING A WALL SILL ASSEMBLY

(71) Applicant: Advanced Architectural Producrs, LLC, Allegan, MI (US)

(72) Inventor: G. Matt Krause, Allegan, MI (US)

(21) Appl. No.: 18/525,762

(22) Filed: Nov. 30, 2023

Related U.S. Application Data
(60) Provisional application No. 63/429,528, filed on Dec. 1, 2022.

(51) Int. Cl. E04F 19/02

(52) U.S. Cl. CPC E04F 19/02

(57) ABSTRACT

A wall sill assembly having a sill base member and an extension sill member. The wall sill assembly can be used in a wall construction having any one or more of a wall substrate, the wall sill assembly, insulation, subframe sheeting, cladding, lower outer substrate/insulation and a lower outer sealing layer. Methods are further disclosed.

### CROSS-REFERENCE TO RELATED APPLICATION

This application claims priority from U.S. Prov. Patent App. Ser. No. 63/429,528 entitled “Wall Sill Assembly And Wall Construction Having A Wall Sill Assembly”, filed Dec. 1, 2022, the entire specification of which is hereby incorporated by reference in its entirety.

### BACKGROUND OF THE DISCLOSURE

### 1. Field of the Disclosure

The disclosure relates in general to building construction, and more particularly, to a wall sill assembly, a wall construction having a wall sill assembly. Methods associated with such construction are likewise disclosed.

### 2. Background Art

Building structures have been known for millennia. Typically, a building structure is composed of a plurality of walls and the like to provide a cavity that is suitable for the desired purpose.

Increasingly, efficiency has become central in the construction of building structures. To that end, it is desirous to provide improvements in the efficiency pertaining to isolation of the elements. Additionally, there is likewise a strive to improve both longevity and repairability to building structures. Such efforts include achievement of longer lifespans for components, as well as improved structures which allow for less costly and quicker repairs.

### SUMMARY OF THE DISCLOSURE

The disclosure is directed in one aspect to a wall sill assembly for use in a wall construction comprising a sill base member and an extension sill member. The sill base member includes a base wall, an inner wall and an extension interface. The base wall has an upper surface, a lower surface opposite the upper surface, and an inner end and an outer end opposite the inner end. The inner wall extends in a direction which is one of oblique and perpendicular to the base wall, from the inner end of the base wall. An extension interface extends in a direction which is one of oblique and perpendicular to the base wall, from the outer end thereof. The extension sill member includes an extension interface coupling, an extension base wall and an extension end wall. The extension base wall extends from the extension interface coupling. The extension end wall extends from the extension base wall opposite the extension base wall. The extension sill member is positionable so that the extension interface coupling at least partially encapsulates the extension interface. The extension base wall extending over a portion of the upper surface of the base wall. The extension end wall extending away from the upper surface of the base wall, in a spaced apart configuration relative to the inner wall.

In some configurations, the sill base member comprises a reinforced polymer member and the extension sill member comprises a metal member.

In some configurations, the inner wall extends substantially perpendicular to the base wall, and the extension end wall is substantially parallel to the base wall.

In some configurations, the extension interface is oblique to the base wall.

In some such configurations, the extension interface extends away from the lower surface of the base wall whereas the inner wall extends away from the upper surface of the base wall.

In some configurations, the extension interface includes a bulbous tip at a terminal end thereof.

In some configurations, the extension interface is structurally configured to follow the contours of the bulbous tip.

In some configurations, the extension end wall further includes an inwardly directed flange extending from an inner surface of the extension interface, and together with the lower surface of the base wall defines a slot.

In some configurations, the inwardly directed flange is positioned at a terminal end of the extension interface, or between a terminal end of the extension interface and the lower surface of the base wall.

In some configurations, the lower surface of the base wall and the inwardly directed flange are substantially parallel to each other.

In some configurations, the extension interface defines an extension interface which defines a box-like configuration with an internal channel and a lower slot providing ingress into the internal channel. The extension end wall extends into the lower slot.

In some configurations, the extension interface extends from the upper surface of the base wall and the inner wall extends from the upper surface of the base wall. The base wall further includes a recessed portion, with a portion of the extension interface extendable into the recessed portion.

In some configurations, the extension interface extends both from the upper surface of the base wall and from the lower surface of the base wall.

In another aspect of the disclosure, a wall construction is disclosed. The wall construction comprises a wall substrate, the wall sill assembly as set forth herein, insulation and cladding. The wall substrate has an outer surface. The inner wall of the wall sill assembly overlies the outer surface. A fastener extends through the inner wall and into the wall substrate to attach the wall sill assembly to the wall substrate. The insulation extends over at least a portion of the wall substrate with a lower surface thereof abutting the upper surface of the base wall of the wall sill assembly. The insulation is fit between the inner wall and the extension end wall of the wall sill assembly. The cladding extending over at least a portion of the insulation and extending over the extension end wall. A fastener extends through the cladding and the insulation and the wall substrate so as to attach the cladding to the wall substrate.

In some configurations, the wall construction further includes a lower outer substrate positioned over a portion of the outer surface of the wall substrate. The lower outer substrate has an upper surface abuttingly approaching the lower surface of the base wall. An outer surface is inboard of the extension interface of the wall sill assembly.

In some configurations, the lower outer substrate abuttingly engages the lower surface of the base wall of the wall sill assembly.

In some configurations, the wall construction further comprises a lower outer sealing layer extending over at least a portion of the lower outer substrate. The lower outer sealing layer includes an upper edge that extends between the extension interface and the extension interface coupling.

In some configurations, the lower outer substrate has a lower outer substrate thickness that is greater than an insulation thickness of the insulation.

In some configurations, the wall construction further includes a subframe sheeting positioned over a portion of the insulation between the insulation and cladding.

In yet another aspect of the disclosure, the disclosure is directed to a method of replacing the extension sill member in the wall construction as set forth herein. The method comprises the steps of: separating the cladding from the wall substrate sufficient to have access to the extension sill member; removing the extension sill member from the wall construction; installing a replacement extension sill member in position of the extension sill member that was removed; and repositioning the cladding relative to the wall substrate.

### BRIEF DESCRIPTION OF THE DRAWINGS

The disclosure will now be described with reference to the drawings wherein:

FIG. 1 of the drawings is a side elevational view (and, cross-sectional view) of a configuration of the wall sill assembly of the present disclosure;

FIG. 2 of the drawings is a cross-sectional view of a wall construction of the present disclosure, showing the wall sill assembly of the present disclosure; and

FIGS. 3a through 3e of the drawings are multiple cross-sectional views of various wall sill assembly configurations, showing, in particular different configurations of the sill base member and the extension sill member; and

FIGS. 4a through 4g of the drawings are multiple cross-sectional view of various wall sill assembly configurations showing different configurations of the sill base members and the extension sill member.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

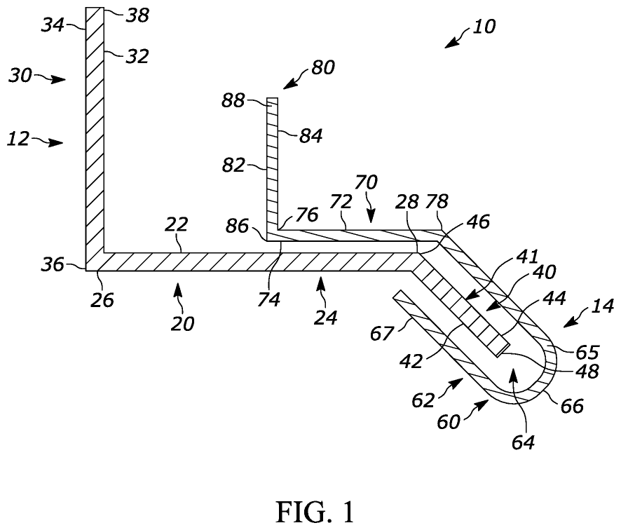

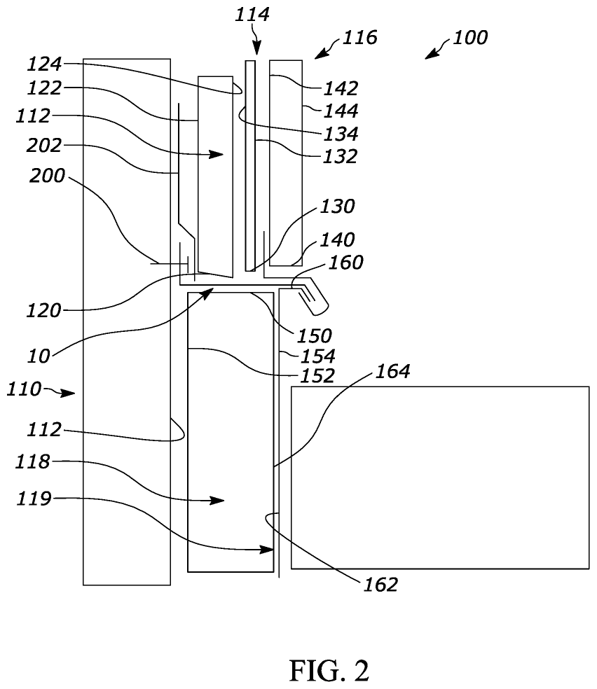

Referring now to the drawings and in particular to FIG. 1, the wall sill assembly is shown generally at 10. With reference to FIG. 2, the wall sill assembly is configured for use in association with the formation of a wall construction, such as wall construction 100. The wall sill construction will be explained in greater detail below, as including wall substrate 100, wall sill assembly 10, insulation 112, subframe sheeting 114, cladding 116, lower outer substrate 118 and lower outer sealing layer 119. Such a construction may be utilized in association with a building, such as a commercial building, however, the construction is not limited thereto, and this is merely to be exemplary. A number of different fasteners, such as fastener 200 may be used to couple the different layers, as may a number of sealants (which may include tape, caulking, sprays) may likewise be used between a number of different layers, in addition to the layer shown.

The wall sill assembly 10 is shown as comprising sill base member 12 and extension sill member 14. The base sill member comprises a pultruded fiber reinforced polymer member. Among other constructions, the construction of the same can have constituents such as those that are disclosed in U.S. Pat. Nos. 8,826,620; 8,833,025; 9,151,052; 9,580,904; 10221573; and 11,066,832, the entire specification of each of which is hereby incorporated by reference in its entirety. Of course, other constructions are likewise contemplated, typically having a polymer base with fiber reinforcement. It will be understood that the sill base member may be of a uniform and/or substantially uniform cross-sectional configuration, while variations are contemplated. Additionally, the sill base member may be of any number of lengths, such as for example, lengths that are 16′ or shorter. Of course, longer sill base members are contemplated, however, as the length become longer, handling and transportation may be more difficult. There is no particular limitation to the length of the sill base members.

The sill base member 12 includes base wall 20, inner wall 30 and extension interface 40. The base wall 30 includes upper surface 22 and lower surface 24, which together define inner end 26 and outer end 28. The inner wall 30 comprises inner surface 32 and outer surface 34, which together define lower end 36 and upper end 38. The inner wall 30 extends generally perpendicularly (+/−20°) relative to the base wall 20 upwardly from upper surface 22. In some configurations, the inner wall may extend from both the upper surface 22 and the lower surface 24 so that the base wall 20 is positioned between the upper end 36 and the lower end 38. The relative thicknesses of the base wall 20 and the inner wall 30 can be the same or can be different.

The extension interface 40 is shown as comprising outer wall 41 which includes inner surface 42, outer surface 44 which defines a proximal end 46 and a distal end 48. In the configuration shown, the extension interface 40 is generally oblique to the base wall and generally extends in a both outward and also downward direction. Again, the thickness of the extension interface relative to the base wall 20 can be varied (also, as to the inner wall 30).

The extension sill member 14 is shown as comprising extension interface coupling 60, extension base wall 70 and extension end wall 80. The extension sill member comprises a metal member (preferably, a sacrificial member, such as a metal that through a galvanic reaction with any of the members of the wall construction, is configured to be sacrificed—and upon degradation, is configured for replacement while minimizing the need to rebuild the wall construction—while being inert relative to the wall sill assembly). For example, the extension sill member may comprise any one of an extruded aluminum, a formed steel (which may be any one of roll formed, folded, press broke, among others, into the desired shape), formed stainless steel (using any of the above formation techniques), a polymer based material and/or a composite material. Preferably, the material from which the extension sill member 14 is formed is inert to the wall sill assembly.

In the configuration shown, the extension interface coupling 60 includes encapsulating wall structure 62 defining slot 64. In the configuration shown, the encapsulating wall structure 62 comprises a U-shaped configuration that is intended to extend over (i.e., to envelope) the extension interface between the proximal and the distal end thereof. The U-shaped configuration includes upper portion 65, edge portion 66 and lower portion 67.

The extension base wall 70 is configured to emanate from the extension interface coupling and to overlie a portion of the upper surface 22 of the base wall 20. The extension base wall 70 includes upper surface 72 and lower surface 74, which defines outer end 76 (that emanates from the upper portion 65 of the encapsulating wall structure 62) and inner end 76.

The extension end wall 80 includes inner surface 82 and outer surface 84, defining lower end 86 and upper end 88. The lower end 86 corresponds to inner end 76 of the extension base wall 70 and generally emanates in a direction that is substantially perpendicular to the extension base wall 70. Generally, the extension base wall terminates between the inner end 26 and the outer end 28 of the base wall 20.

A number of different configurations for the extension interface coupling. That is, the extension interface coupling 60 may cover portions of the lower surface of the base wall. Additionally, it is contemplated (and shown in the various figures) that the interface with the wall sill assembly may be one or more of interlocking by way of a cleat, a rail, geometric angles, shelving, snap fit coupling, interference fit coupling, compression fits, among others.

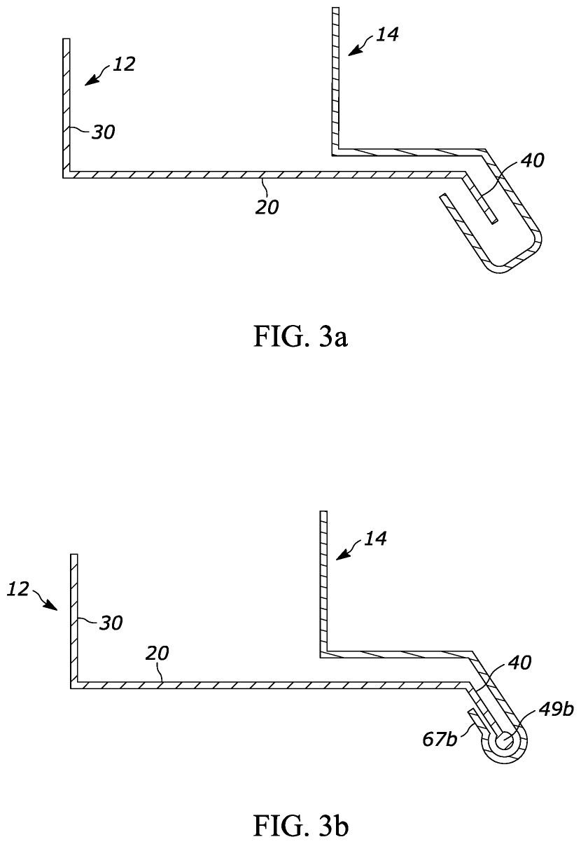

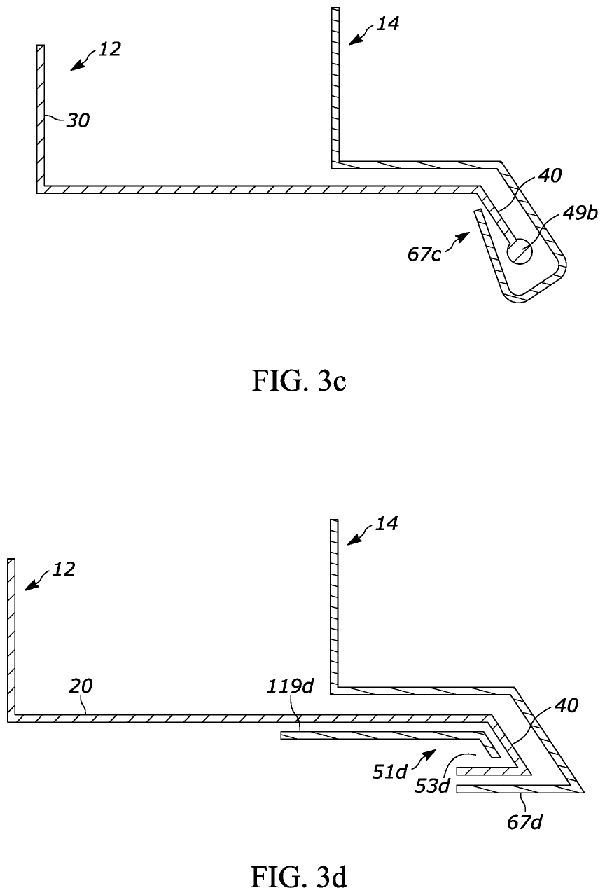

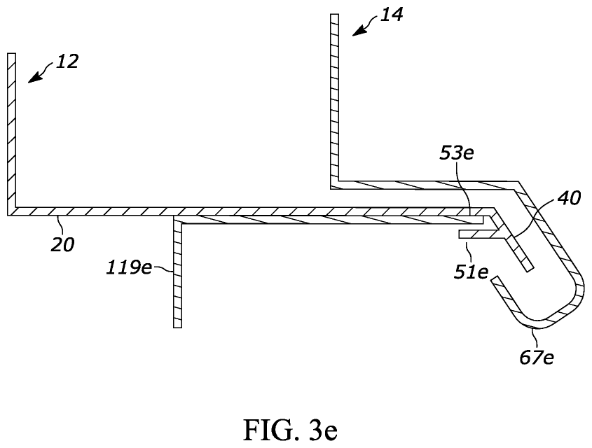

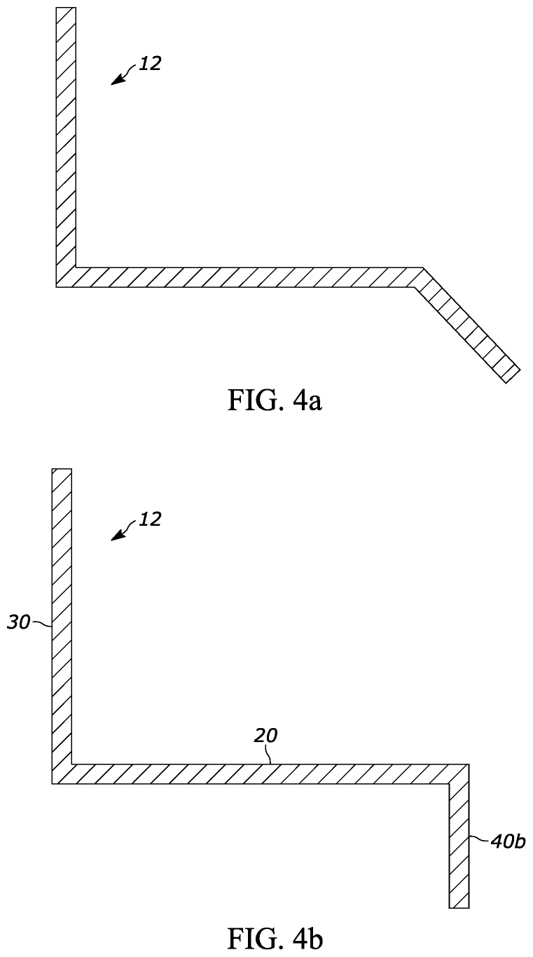

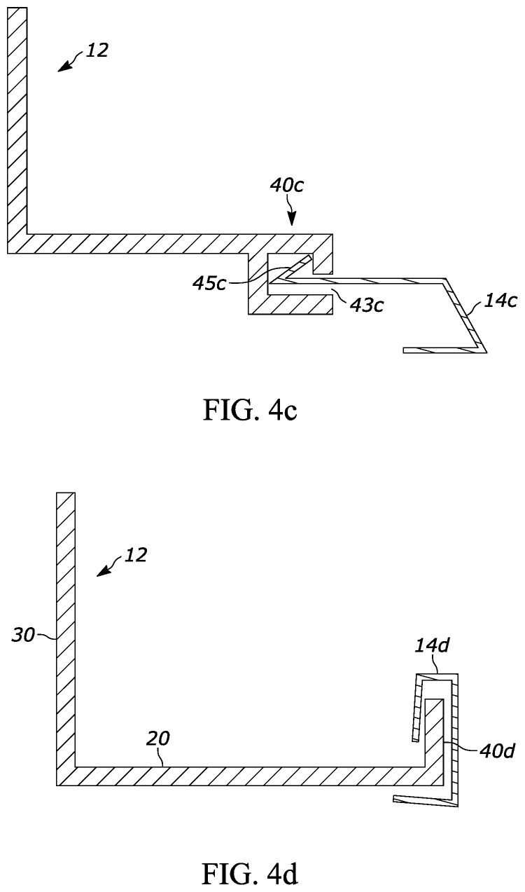

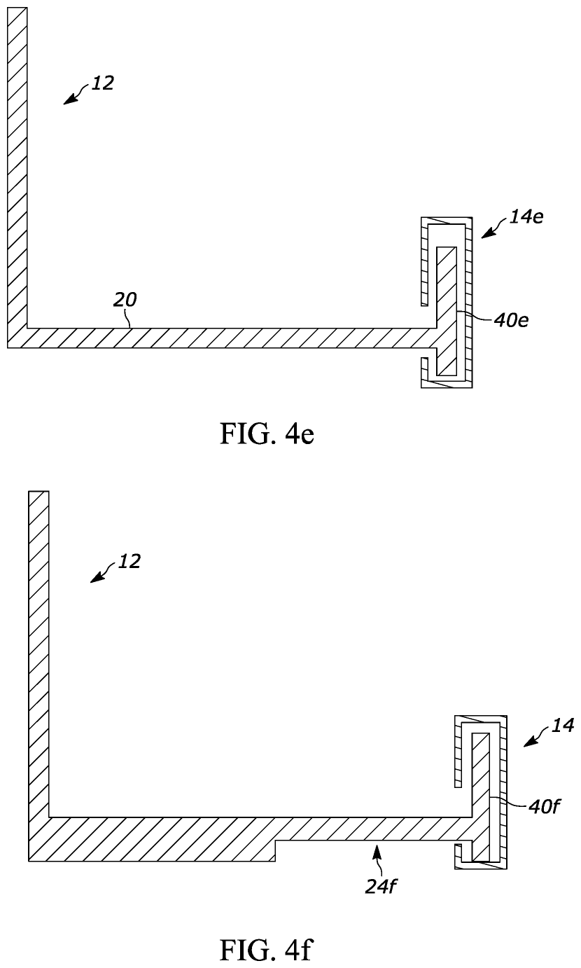

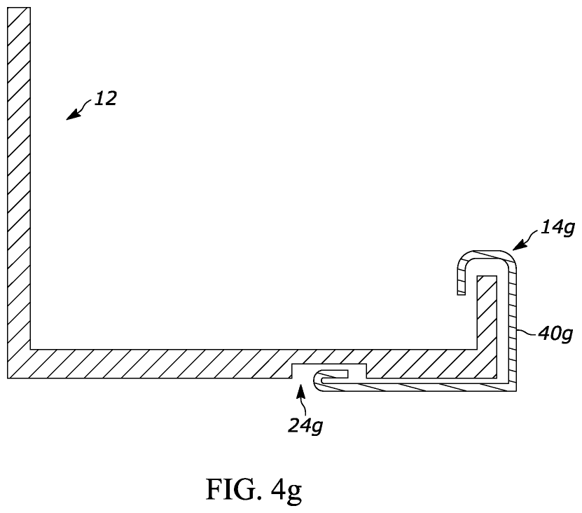

More specifically, a number of different configurations of the wall sill assembly 10 are shown in FIGS. 3a through 3e as well as in FIGS. 4a through 4g. Referring to FIG. 3a, the configuration of the sill base member and the extension sill member are those shown in FIG. 1. With reference to FIG. 3b, the configuration of the sill base member is such that it includes a bulbous end 49b at the distal end of the extension interface 40. In the configuration of FIG. 3b, the lower portion 67b of the extension interface coupling is configured to follow the contours of the bulbous end 49b. In such a configuration, the terminal portion of the lower portion 67b follows the contours of the inner surface of the extension interface.

The configuration of FIG. 3c discloses a sill base member having a bulbous end 49b, however, in the configuration of FIG. 3c, the lower portion 67c of the extension interface coupling is configured to extend about the bulbous end 49b spaced apart therefrom and then directed inwardly to contact the inner surface of the extension interface at a terminal end thereof, instead of following the contours of the inner surface of the extension interface.

The configuration of FIG. 3d discloses a structure of the extension interface 40 that includes an inwardly extending flange 51d at the terminal end of the extension interface. The structure defines a slot 53d. The lower outer sealing layer 119d can be placed into the slot (and may include a bent end to follow the contours of the inner surface of the extension interface). The inwardly extending flange 51d can be substantially parallel to the base wall 20. Similarly, the lower portion 67d of the extension sill member generally follows the flange 51d along the lower end thereof. In the configuration shown, the lower portion 67d is substantially parallel to the inwardly directed flange and the base wall.

In the configuration of FIG. 3e, the inwardly directed flange 51e can be spaced apart from the terminal end of the extension interface so as to define a slot 53e that is narrower than the slot 53d. In the configuration shown, the slot can be sized to receive the lower outer sealing layer 119e. In the configuration shown the lower portion 67e follows the extension interface 40 terminating proximate the inwardly directed flange 51e.

In the configuration of FIG. 4a, the sill base member is shown that is substantially similar to that of the configuration of FIG. 1. In the configuration of FIG. 4b, the extension interface 40b is substantially perpendicular to the base wall 20 and substantially parallel to the inner wall 30. The extension interface depends in a direction opposite that of the inner wall.

In the configuration of FIG. 4c, the extension interface 40c substantially forms a box-like configuration defining an internal channel 43c, with a lower slot 45c. The lower slot 45c opens in an outward direction at the lower end of the front wall portion of the box-like configuration. In such a configuration, the extension sill member may include a portion that is slidably inserted into the internal channel 43c with a portion extending out of lower slot 45c so as to define a c-channel configuration. Of course, other configurations are contemplated. The portion within the internal channel 43c substantially precludes rotation of the extension sill member relative to the sill base member.

In the configuration of FIG. 4d, the extension interface 40d extends in the same direction as the inner wall 30 so that the two are in a spaced apart, and generally parallel configuration. The extension sill member is shown as generally encapsulating the extension interface and a portion of the base wall 20 along a portion of the lower surface thereof. Similarly, in the configuration of FIG. 4e, the extension interface extends in both an upward and downward direction, while being substantially parallel to and spaced apart from the inner wall. In such a configuration, the extension sill member encapsulates the extension interface 40e.

In the configuration of FIG. 4f, the extension interface 40f is substantially similar to that shown in FIG. 4e, with the lower surface of the base wall 20 including a recessed portion 24f (or a portion of decreased thickness). The recessed portion extends from the extension interface 40f toward the inner end of the base wall (in the configuration shown, about mid-way to the base wall from the extension interface). In the configuration of FIG. 4g, the recessed portion is spaced apart from the extension interface 40g and the inner wall 30. In such a configuration, the extension interface extends along the lower surface of the base wall and includes an interface that fits within the recessed portion 24g. Of course, other combinations are contemplated, including combinations that combine features of the different configurations shown in FIGS. 3a through 3e and 4a through 4g.

The wall construction 100 is shown as incorporating the wall assembly. A number of different configurations are shown in FIG. 3, with a more detailed construction shown in FIG. 2. In such a configuration, the wall substrate 110 includes outer surface 113. The insulation 112 includes lower surface 120, inner surface 122 and outer surface 124. The subframe sheeting 114 includes lower surface 130, inner surface 132 and outer surface 134. The cladding 116 includes lower surface 140, inner surface 142 and outer surface 144. The lower outer substrate includes upper surface 150, inner surface 152 and outer surface 154. The lower outer sealing layer 119 includes upper edge 160, inner surface 162 and outer surface 164.

In the wall construction 100, shown in FIG. 2 in cross-section with the understanding that the wall construction may define a wall having any length, height and width dimensions. the wall substrate is typically formed from a plurality of beams and may include an outer wall affixed to the plurality of beams forming the outer surface 113.

The wall sill assembly 10 is then coupled to the wall substrate by attaching the inner wall to the outer surface 113 using fasteners, such as fastener 200 at predetermined points along the length thereof. A sealant 202 (which may comprise a sealant that is a liquid, or a tape based member) is applied over a portion of the inner wall 30 and the outer surface of the wall substrate.

Below the base wall, and, abuttingly engaging the same, lower outer substrate 118 may be positioned. The lower outer substrate 118 includes upper surface 150 that abuttingly engages the lower surface 24 of the base wall 20. It will be understood that the lower outer substrate may comprise any number of different materials in one or more layers, and may include insulation as well. Above the sill base member, insulation is provided to overlie the sealant 202, the inner wall 30, and the outer surface 113 of the wall substrate 110. The lower surface 120 of the insulation 112 meets the base wall 20. A subframe sheeting 114 may be positioned over the insulation 112 and may be of the same configuration as the insulation so as to fully cover the insulation.

Once the insulation is positioned, the extension sill member 14 can be slid or snapped into position. In many of the configurations, the extension interface coupling 60 extends over the extension interface 40 with the extension base wall extending over a portion of the upper surface of the base wall 20 and with the extension end wall extending over a portion of the subframe sheeting 114 so that the insulation and the subframe sheeting is captured between the extension end wall 80 of the extension sill member 14 and the inner wall 30 of the sill base member 12.

In a configuration that includes the lower outer sealing layer 119, the upper edge 160 of the lower outer sealing layer 119 can be positioned prior to the installation of the extension sill member 14 so that the lower portion 67 of the extension interface 40 can be positioned to overlie the upper edge 160 of the lower outer sealing layer 119.

Once the extension sill member 114 is installed, the cladding 116 can be positioned over the extension end wall 80 as well as the subframe sheeting 114. Fasteners can be directed through the cladding 116, the subframe sheeting 114, the insulation 112 and into the wall substrate 110 so as to attach the cladding to the underlying wall substrate 110. In some configurations, the subframe sheeting may be omitted, as desired.

It will be understood that where the extension sill member has been damaged or has degraded, the same can be replaced solely by moving the cladding, or sufficiently decoupling the cladding so as to allow for removal of the extension sill member, as it is separate from the base sill member. In some configurations it can simply be pulled out, whereas in other configurations it may be slid out of engagement with the sill base member 12. Additionally, the base sill member is configured so as to provide a thermal gap between the cladding and the wall substrate, as the configuration preferably comprises a fiber reinforced polymer member, for example, formed through pultrusion or the like.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. A wall sill assembly for use in a wall construction comprising:
a sill base member including:
a base wall having an upper surface, a lower surface opposite the upper surface, and an inner end and an outer end opposite the inner end;
an inner wall extending in a direction which is one of oblique and perpendicular to the base wall, from the inner end of the base wall;
an extension interface extending in a direction which is one of oblique and perpendicular to the base wall, from the outer end thereof; and
an extension sill member including:
an extension interface coupling;
an extension base wall extending from the extension interface coupling; and
an extension end wall extending from the extension base wall opposite the extension base wall;
wherein the extension sill member is positionable so that the extension interface coupling at least partially encapsulates the extension interface, with the extension base wall extending over a portion of the upper surface of the base wall, and with the extension end wall extending away from the upper surface of the base wall, in a spaced apart configuration relative to the inner wall.

2. The wall sill assembly of claim 1 wherein the sill base member comprises a reinforced polymer member and the extension sill member comprises a metal member.

3. The wall sill assembly of claim 1 wherein the inner wall extends substantially perpendicular to the base wall, and the extension end wall is substantially parallel to the base wall.

4. The wall sill assembly of claim 3 wherein the extension interface is oblique to the base wall.

5. The wall sill assembly of claim 4 wherein the extension interface extends away from the lower surface of the base wall whereas the inner wall extends away from the upper surface of the base wall.

6. The wall sill assembly of claim 1 wherein the extension interface includes a bulbous tip at a terminal end thereof.

7. The wall sill assembly of claim 6 wherein the extension interface is structurally configured to follow the contours of the bulbous tip.

8. The wall sill assembly of claim 1 wherein the extension end wall further includes an inwardly directed flange extending from an inner surface of the extension interface, and together with the lower surface of the base wall defines a slot.

9. The wall sill assembly of claim 8 wherein the inwardly directed flange is positioned at a terminal end of the extension interface, or between a terminal end of the extension interface and the lower surface of the base wall.

10. The wall sill assembly of claim 8 wherein the lower surface of the base wall and the inwardly directed flange are substantially parallel to each other.

11. The wall sill assembly of claim 1 wherein the extension interface defines an extension interface which defines a box-like configuration with an internal channel and a lower slot providing ingress into the internal channel, wherein the extension end wall extends into the lower slot.

12. The wall sill assembly of claim 1 wherein the extension interface extends from the upper surface of the base wall and the inner wall extends from the upper surface of the base wall, the base wall further including a recessed portion, with a portion of the extension interface extendable into the recessed portion.

13. The wall sill assembly of claim 1 wherein the extension interface extends both from the upper surface of the base wall and from the lower surface of the base wall.

14. A wall construction comprising:
a wall substrate having an outer surface;
the wall sill assembly of claim 1, wherein the inner wall overlies the outer surface, with a fastener extending through the inner wall and into the wall substrate to attach the wall sill assembly to the wall substrate;
an insulation extending over at least a portion of the wall substrate with a lower surface thereof abutting the upper surface of the base wall of the wall sill assembly, the insulation being fit between the inner wall and the extension end wall of the wall sill assembly; and
a cladding extending over at least a portion of the insulation and extending over the extension end wall, with a fastener extending through the cladding and the insulation and the wall substrate so as to attach the cladding to the wall substrate.

15. The wall construction of claim 14 further comprising a lower outer substrate positioned over a portion of the outer surface of the wall substrate, the lower outer substrate having an upper surface abuttingly approaching the lower surface of the base wall, with an outer surface that is inboard of the extension interface of the wall sill assembly.

16. The wall construction of claim 15 wherein the lower outer substrate abuttingly engages the lower surface of the base wall of the wall sill assembly.

17. The wall construction of claim 15 further comprising:
a lower outer sealing layer extending over at least a portion of the lower outer substrate, the lower outer sealing layer including an upper edge that extends between the extension interface and the extension interface coupling.

18. The wall construction of claim 15 wherein the lower outer substrate has a lower outer substrate thickness that is greater than an insulation thickness of the insulation.

19. The wall construction of claim 14 further comprising a subframe sheeting positioned over a portion of the insulation between the insulation and cladding.

20. A method of replacing the extension sill member in the wall construction of claim 15, the method comprising the steps of:
separating the cladding from the wall substrate sufficient to have access to the extension sill member;
removing the extension sill member from the wall construction;
installing a replacement extension sill member in position of the extension sill member that was removed; and
repositioning the cladding relative to the wall substrate.
